(19) United States
(12) Patent Application Publication
(10) Pub. No.: US 2015/0350412 A1
(43) Pub. Date: Dec. 3, 2015

(54) ELECTRONIC DEVICE

(71) Applicant: KYOCERA Corporation, Kyoto-shi (JP)

(72) Inventor: Yuka NAGASHIMA, Osaka (JP)

(73) Assignee: KYOCERA Corporation

(21) Appl. No.: 14/721,909

(22) Filed: May 26, 2015

(30) Foreign Application Priority Data
May 28, 2014 (JP) 2014-110122

(51) Int. Cl. H04M 1/725; G08B 21/06

(52) U.S. Cl. CPC H04M 1/72577; G08B 21/06; H04M 1/72569; H04M 1/72552

(57) ABSTRACT

An input module receives an instruction from a user. A sleepiness detection module detects a sleepy state of the user. When the user inputs an instruction through the input module in the case where the sleepy state has been detected, a control module restricts execution of the instruction.

### CROSS-REFERENCE TO RELATED APPLICATION

The present application claims priority under 35 U.S.C. §119 to Japanese Patent Application No. 2014-110122, filed on May 28, 2014, entitled “Electronic Device.” The content of which is incorporated by reference herein in its entirety.

### FIELD

The present disclosure relates to an electronic device, and particularly to an electronic device having a function of detecting a user's sleepy state.

### BACKGROUND

A device having a function of detecting a user's sleepy state is conventionally known.

For example, a device that gives a warning to a driver for safety if the driver's sleepy state has been detected is disclosed.

### SUMMARY

An electronic device of an embodiment includes an input module, a detection module, and a control module. The input module is configured to receive an instruction from a user. The detection module is configured to detect a sleepy state of the user. The control module is configured to, when the user inputs an instruction through the input module in the case where the sleepy state has been detected, impose a restriction on execution of the instruction.

An electronic device of another embodiment includes a detection module, an earphone jack, and a control module. The detection module is configured to detect a sleepy state of a user. The earphone jack can be connected to an earphone. The control module is configured to, when the earphone is disconnected from the earphone jack in the case where the sleepy state has been detected, produce an alarm sound.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram representing a configuration of a smartphone of an embodiment and an earphone connected to the smartphone.

FIG. 2 is a diagram representing a state of transmission and reception of infrared rays.

FIG. 3 is a flowchart representing a procedure of executing or restricting a user's instruction based on detection of a sleepy state in a first embodiment.

FIG. 4 is a diagram representing a screen for instructing withdrawal of a restriction.

FIG. 5 represents at (a) to (d) exemplary screens displayed for an instruction to delete a file.

FIG. 6 represents at (a) and (b) exemplary screens displayed for a call instruction.

FIG. 7 represents at (a) and (b) exemplary screens displayed for an instruction to transmit an e-mail message.

FIG. 8 is a flowchart representing a procedure of executing or restricting a user's instruction based on detection of a sleepy state in a second embodiment.

FIG. 9 is a diagram representing a locked state of a screen.

FIG. 10 is a flowchart representing a procedure of executing or restricting a user's instruction based on detection of a sleepy state in a third embodiment.

FIG. 11 is a diagram representing a state in which an earphone has been disconnected from an earphone jack when a sleepy state has been detected.

### DETAILED DESCRIPTION

Hereinafter, embodiments will be described with reference to the drawings.

A user using a personal computer or a portable terminal may perform a key operation or a touch operation while feeling sleepy. If the user performs an operation while feeling sleepy, an important file may be deleted unintentionally, or e-mail message transmission or a telephone call may be made unintentionally, which may bother others. The personal computer or the portable terminal may be stolen by others.

In such an operation of the personal computer or the portable terminal, it is not necessary to immediately give a warning for safety just because sleepiness has been detected as in the case of driving a vehicle. In the case where a user wishes to maintain the sleepy state, being awakened by a warning is troublesome.

The above-described problems will be solved by the following disclosure.

### First Embodiment

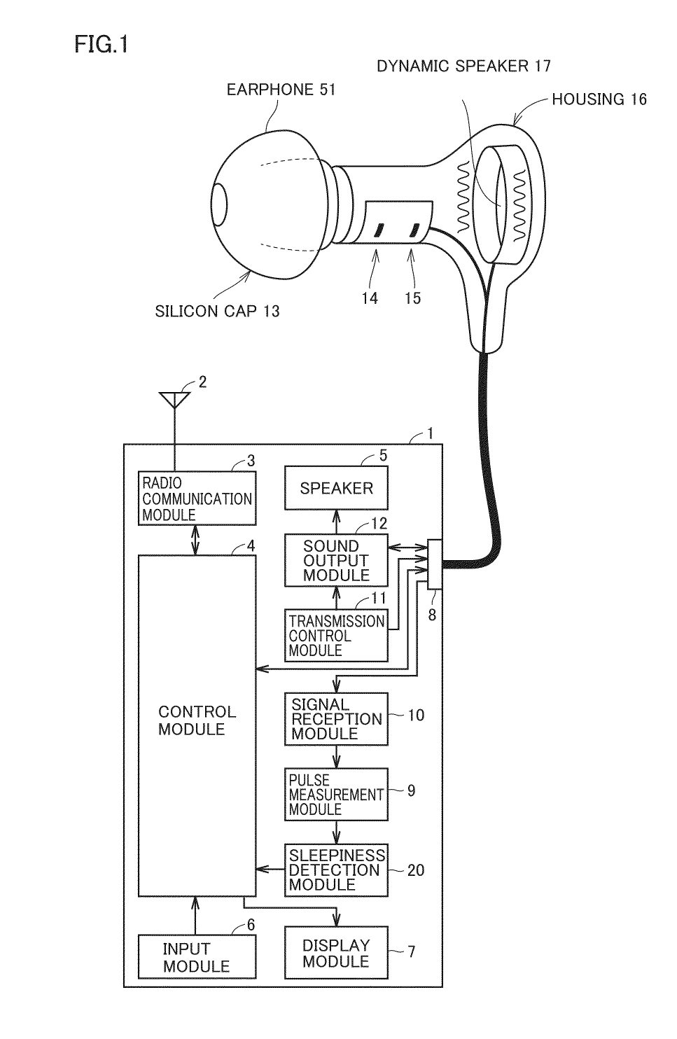

FIG. 1 is a diagram representing a configuration of a smartphone 1 of an embodiment and an earphone 51 connected to smartphone 1.

Referring to FIG. 1, smartphone 1 includes an antenna 2, a radio communication module 3, an earphone jack 8, a control module 4, an input module 6, a display module 7, a sound output module 12, a speaker 5, a transmission control module 11, a signal reception module 10, a pulse measurement module 9, and a sleepiness detection module 20. Smartphone 1 can include one or more processors and a memory module storing a program therein. By reading and executing the program stored in the memory module, the one or more processors may operate as control module 4, transmission control module 11, signal reception module 10, pulse measurement module 9, and sleepiness detection module 20. The memory module may include, for example, a flash memory which is a nonvolatile semiconductor memory, or a HDD (Hard Disk Drive) which is a memory device.

Earphone 51 includes a silicon cap 13, a housing 16, a dynamic speaker 17, an infrared transmitter 14, and an infrared receiver 15. Silicon cap 13 may be replaced with a cap made of another material.

Input module 6 can include a touch panel or the like, for example. Input module 6 can accept an input from a user.

Display module 7 can include a liquid crystal display, for example. Display module 7 may include another type of display, such as an organic EL (Electro-Luminescence) display.

Radio communication module 3 can establish radio communication with a radio base station through antenna 2.

Sound output module 12 can output a sound signal to speaker 5 or earphone 51.

When earphone 51 is connected to earphone jack 8 of smartphone 1, sound output module 12 can output a sound signal to dynamic speaker 17 in earphone 51.

When earphone 51 is not connected to earphone jack 8 of smartphone 1, sound output module 12 can output a sound signal to internal speaker 5.

Transmission control module 11 can output a signal for controlling transmission of infrared rays in infrared transmitter 14 to earphone jack 8.

Signal reception module 10 can receive a waveform signal of infrared rays received by infrared receiver 15 from earphone jack 8.

Housing 16 can store dynamic speaker 17, infrared transmitter 14, and infrared receiver 15. Housing 16 can function as a section where a sound output from dynamic speaker 17 resonates. Silicon cap 13 can be mounted on housing 16.

Infrared transmitter 14 can transmit infrared rays.

Infrared receiver 15 can receive a reflected wave as a reflection of transmitted infrared rays from the skin of a user's external ear.

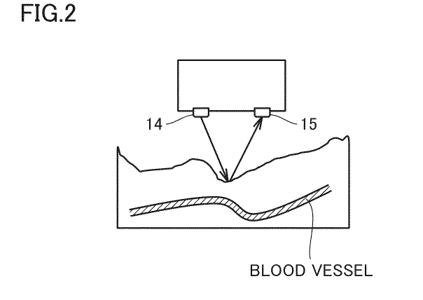

FIG. 2 is a diagram representing a state of transmission and reception of infrared rays.

A user can wear earphone 51 on his/her ear such that infrared transmitter 14 and infrared receiver 15 face the skin of an external ear. A transmitted wave transmitted from infrared transmitter 14 can be reflected from the skin of the external ear and can be received by infrared receiver 15 as a received wave. There is a blood vessel under the skin of the external ear, through which blood flows. For example, infrared transmitter 14 can transmit a transmitted wave, and infrared receiver 15 can receive a reflected wave. When a blood vessel contracts by a pulse, the amount of absorbed infrared rays is changed, so that the cycle of a received wave becomes equal to the cycle of a pulse. The pulse can be calculated by the cycle of this received wave.

Pulse measurement module 9 can measure the pulse of a user wearing earphone 51 based on a waveform signal of the received infrared rays.

Sleepiness detection module 20 can detect a user's sleepy state based on the pulse measured by pulse measurement module 9. More specifically, sleepiness detection module 20 can generate time series data of a pulse interval, for example, as described in Japanese Patent Laying-Open No. 2007-313358. In the case where the current pulse interval is relatively long in the time series data, sleepiness detection module 20 can detect that a user is in a sleepy state. In the case where the current pulse interval is relatively short in the time series data, sleepiness detection module 20 can detect that a user is in a wakeful state. The sleepy state also includes a sleeping state.

Control module 4 can execute the whole operation of smartphone 1. Particularly in the case where a sleepy state has been detected, when a user's instruction is input through input module 6, control module 4 can restrict execution of the user's instruction.

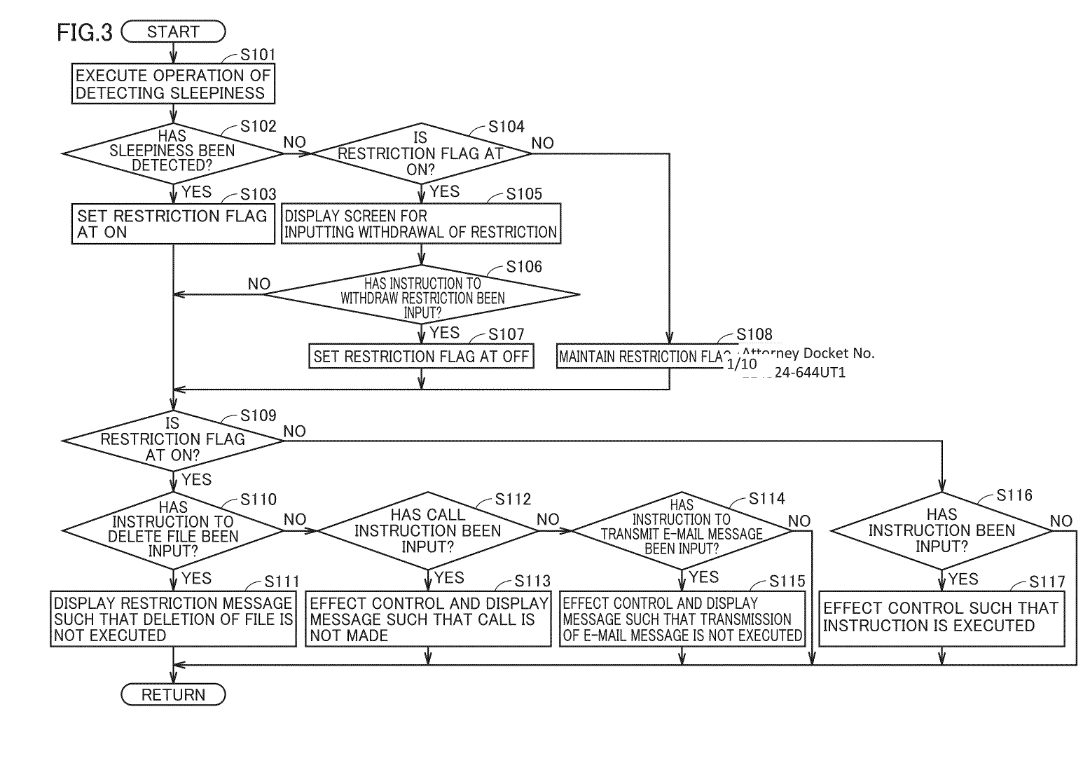

FIG. 3 is a flowchart representing a procedure of executing or restricting a user's instruction based on detection of a sleepy state in the first embodiment.

The procedure shown in this flowchart can be repeatedly executed at predetermined time intervals. The on/off state of a restriction flag set in a previous procedure can be continuously reflected in the current procedure.

Referring to FIG. 3, in step S101, sleepiness detection module 20 can detect a user's sleepy state based on the pulse of the user measured by pulse measurement module 9.

In the case where a sleepy state has been detected in step S102 (YES), the process proceeds to step S103. In the case where a sleepy state has not been detected (NO), the process proceeds to step S104.

In step S103, control module 4 sets a restriction flag at ON, and the process proceeds to step S109.

In step S104, in the case where the restriction flag has been set at ON (YES), the process proceeds to step S105. In the case where the restriction flag has been set at OFF (NO), the process proceeds to step S108.

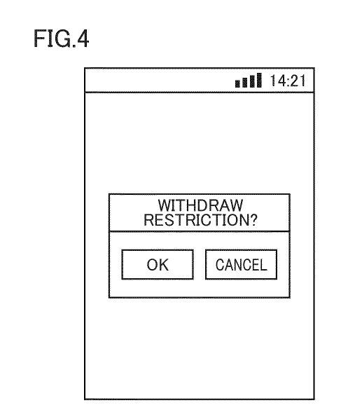

In step S105, control module 4 can cause a screen for inputting withdrawal of a restriction as shown in FIG. 4 to be displayed on display module 7.

In step S106, in the case where a user has input an instruction to withdraw a restriction through input module 6 (YES), the process proceeds to step S107. In the case where the user has not input an instruction to withdraw a restriction (NO), the process proceeds to step S109.

In step S107, control module 4 sets the restriction flag at OFF, and the process proceeds to step S109.

In step S108, control module 4 maintains the restriction flag at OFF, and the process proceeds to step S109.

In step S109, control module 4 advances the process to step S110 in the case where the restriction flag is at ON (YES), and advances the process to step S116 in the case where the restriction flag is at OFF (NO).

In step S110, control module 4 advances the process to step S111 in the case where the user has input an instruction to delete a file through input module 6 (YES), and advances the process to step S112 in the case where the user has not input an instruction to delete a file (NO).

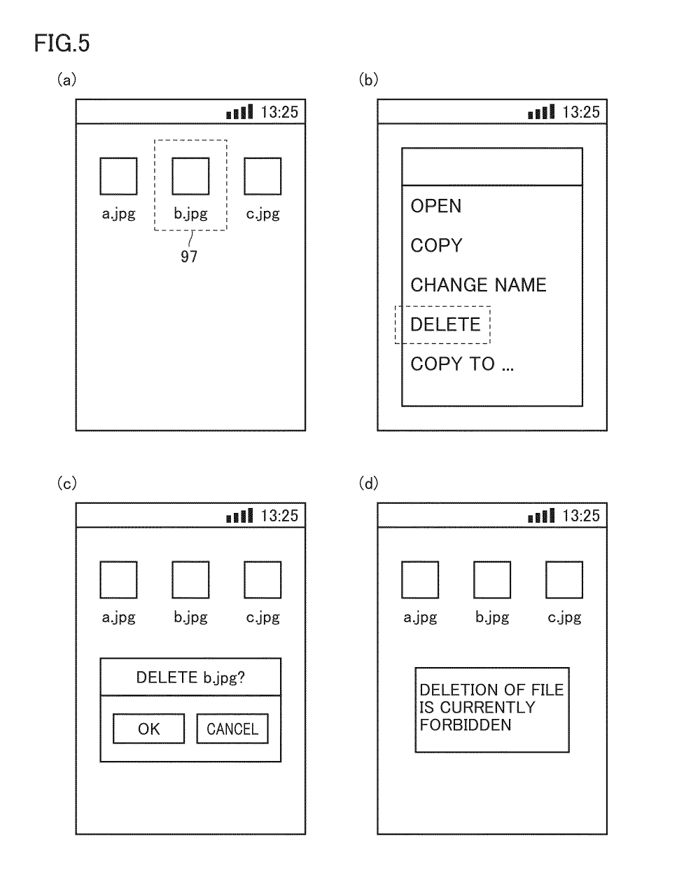

For example, by pressing and holding an icon 97 indicating a specific file (b.jpg) as shown in FIG. 5 at (a), a screen for selecting deletion of a file can be displayed as shown in FIG. 5 at (b). When the user has selected deletion, a screen for confirming deletion of a file can be displayed as shown in FIG. 5 at (c). When the user instructs confirmation of deletion of a file (selects OK), the process proceeds to step S111.

In step S111, control module 4 can effect control such that deletion of a file is not executed, and a message saying that deletion of a file is not executed can be displayed on display module 7. For example, deletion of a file is not executed while a message saying that “deletion of a file is currently forbidden” is displayed as shown in FIG. 5 at (d).

In step S112, control module 4 advances the process to step S113 in the case where the user has input a call instruction through input module 6 (YES), and advances the process to step S114 in the case where the user has not input a call instruction through input module 6 (NO).

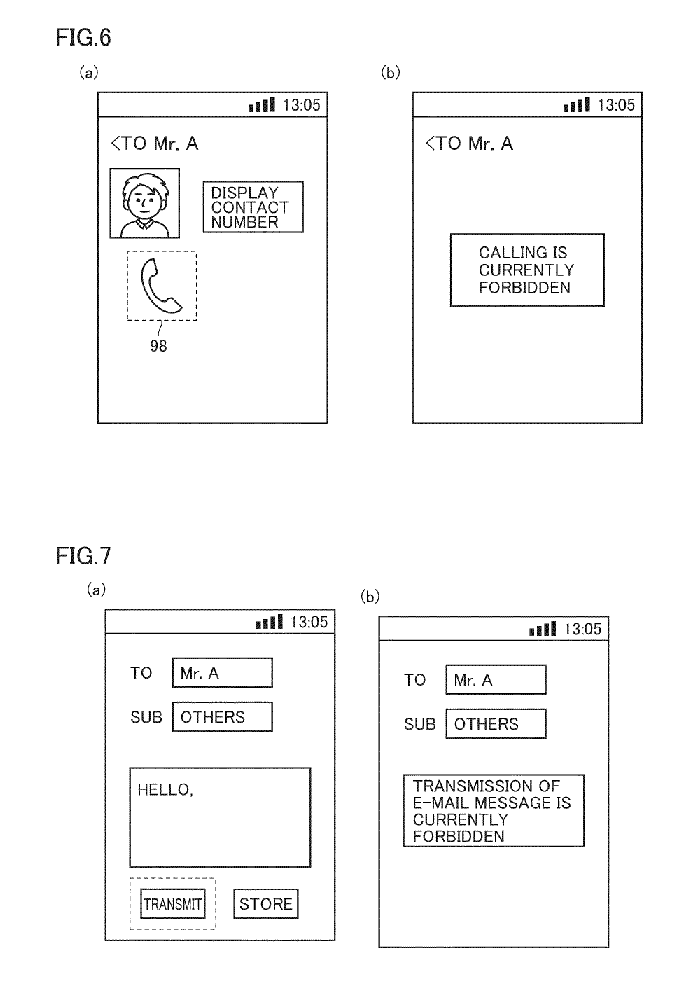

For example, as shown in FIG. 6 at (a), the process proceeds to step S113 by touching an icon 98 indicating a call.

In step S113, control module 4 can effect control such that a call is not executed, and can cause a message saying that calling is not executed to be displayed on display module 7. For example, calling is not executed while a message saying that “calling is currently forbidden” as shown in FIG. 6 at (b) is displayed.

In step S114, control module 4 advances the process to step S115 in the case where the user has input an instruction to transmit an e-mail message through input module 6 (YES), and terminates the process in the case where the user has not input an instruction to transmit an e-mail message (NO).

For example, as shown in FIG. 7 at (a), the user can create a destination (TO), a title (SUB), and an e-mail sentence of an e-mail message through input module 6, and when transmission has been selected, the process proceeds to step S115.

In step S115, control module 4 can effect control such that transmission of an e-mail message is not executed, and can cause a message saying that transmission of an e-mail message is not executed to be displayed on display module 7. For example, no e-mail message is transmitted while a message saying that “transmission of an e-mail message is currently forbidden” as shown in FIG. 7 at (b) is displayed.

In step S116, control module 4 advances the process to step S117 in the case where the user has input an instruction through input module 6.

In step S117, control module 4 can effect control such that a user's instruction is executed.

As described above, according to the first embodiment, even if a user inputs an instruction to delete a file, make a call, or transmit an e-mail message, execution of the instruction can be restrained if a user's sleepy state has been detected. This can prevent unintentional deletion of an important file or unintentional transmission of a call or an e-mail message to annoy others.

In the first embodiment, the case where an instruction to delete a file, make a call, or transmit an e-mail message is input has been described by way of example. In the case where another instruction to edit a schedule, edit an address book, or the like is input, it is also possible not to execute such an instruction.

### Second Embodiment

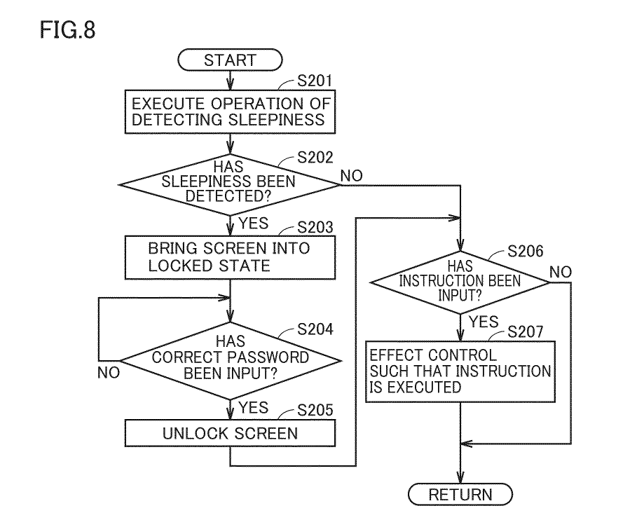

FIG. 8 is a flowchart representing a procedure of executing or restricting a user's instruction based on detection of a sleepy state in a second embodiment. The procedure shown in this flowchart can be repeatedly executed at predetermined time intervals.

Referring to FIG. 8, in step S201, sleepiness detection module 20 can detect a user's sleepy state based on the pulse of the user measured by pulse measurement module 9.

In step S202, in the case where a sleepy state has been detected (YES), the process proceeds to step S203. In the case where a sleepy state has not been detected (NO), the process proceeds to step S206.

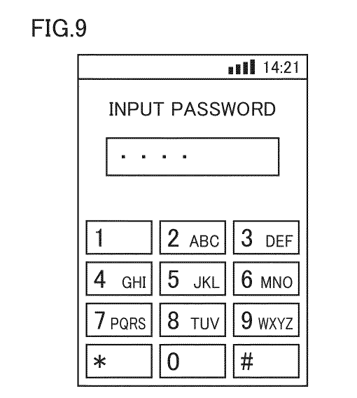

In step S203, control module 4 can bring a screen into a locked state. In the locked state of the screen, a screen as shown in FIG. 9, for example, can be displayed. In the locked state of the screen, when an instruction is input from a user through input module 6, control module 4 can effect control such that the instruction is not executed in the case where this instruction is different from an instruction to unlock the screen.

In step S203, in the case where a user has input a correct password through input module 6 (YES), control module 4 advances the process to step S205.

In step S205, control module 4 can unlock the screen, and the process proceeds to step S206.

In step S206, in the case where the user has input an instruction through input module 6 (YES), control module 4 advances the process to step S207.

In step S207, control module 4 can effect control such that the instruction from the user is executed.

As described above, according to the second embodiment, the screen is locked in the case where a user's sleepy state has been detected. Therefore, even if an instruction is input from a user, it is possible to restrain the instruction from being executed. This can prevent a wrong instruction made by a user in a sleepy state from being executed.

According to the second embodiment, the screen is locked in the case where a user's sleepy state has been detected. Therefore, smartphone 1 can be prevented from being freely operated by others in the case where the user is in a sleepy state. Accordingly, it is possible to prevent data stored in smartphone 1 from being freely accessed or deleted by others, for example.

In the above-described example, in the locked state of the screen, when an instruction is input from a user through input module 6, control module 4 can effect control such that the instruction is not executed in the case where this instruction is different from an instruction to unlock the screen, however, control module 4 may effect control such that some instructions including an instruction which is different from an instruction to unlock the screen are executed. If input module 6 includes a touch panel and hard keys, when an instruction is input from a user with the hard keys in the locked state of the screen, the instruction may be executed. In the locked state of the screen, when an instruction is input from a user through input module 6, control can be effected such that some instructions including an instruction to unlock the screen are executed and other instructions are not executed.

### Third Embodiment

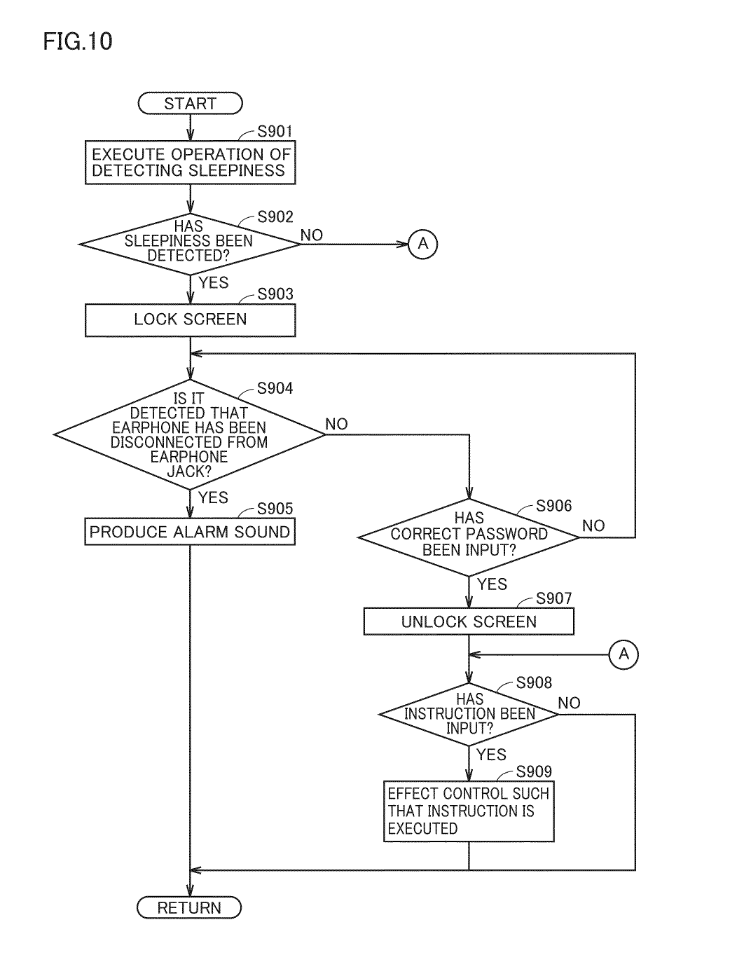

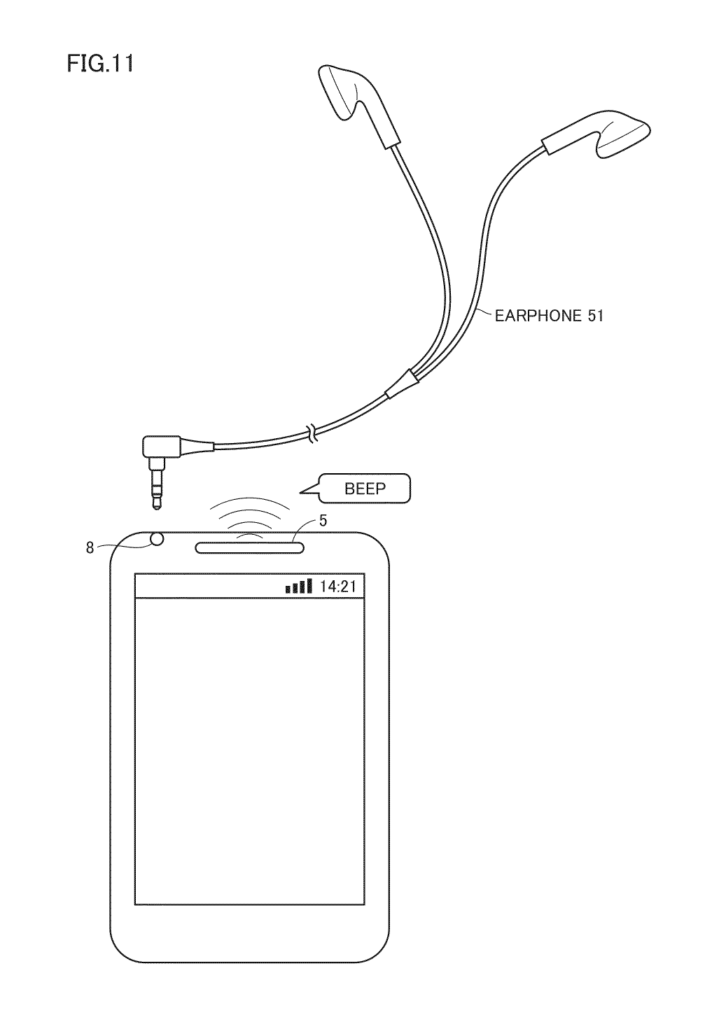

FIG. 10 is a flowchart representing a procedure of executing or restricting a user's instruction based on detection of a sleepy state in a third embodiment. The procedure shown in this flowchart can be repeatedly executed at predetermined time intervals.

Referring to FIG. 10, in step S901, sleepiness detection module 20 can detect a user's sleepy state based on the pulse of the user measured by pulse measurement module 9.

In step S902, in the case where a sleepy state has been detected (YES), the process proceeds to step S903. In the case where a sleepy state has not been detected (NO), the process proceeds to step S908.

In step S903, control module 4 can bring a screen into a locked state.

In step S904, when it is detected that earphone 51 has been disconnected from earphone jack 8 (YES), control module 4 advances the process to step S905. When it is not detected that earphone 51 has been disconnected from earphone jack 8 (NO), control module 4 advances the process to step S906.

In step S905, control module 4 can cause sound output module 12 to output a sound signal of an alarm sound. Since earphone 51 is not connected to earphone jack 8 as shown in FIG. 11, sound output module 12 can output a sound signal to speaker 5, and an alarm sound is emitted from speaker 5.

In step S906, in the case where a user has input a correct password through input module 6 (YES), control module 4 advances the process to step S907. In the case where a user has not input the correct password through input module 6 (NO), control module 4 advances the process to step S904.

In step S907, control module 4 can unlock the screen, and the process proceeds to step S908.

In step S908, in the case where the user has input an instruction through input module 6 (YES), control module 4 advances the process to step S909.

In step S909, control module 4 can effect control such that the instruction from the user is executed.

As described above, according to the third embodiment, an alarm sound can be output when the earphone is disconnected from the earphone jack in the case where a user's sleepy state has been detected. Accordingly, an alarm sound can be output when a user reaches a sleepy state while wearing the earphone on his/her ear and another person disconnects the earphone from the smartphone trying to take the smartphone away without asking. As a result, the user will wake up and warn the other person who tried to take the smartphone away, so that the theft of the smartphone can be prevented.

In the third embodiment, an alarm sound is output when the earphone is disconnected from the earphone jack. In the case where a user's sleepy state has been detected, an alarm sound may also be output when the earphone is pulled out from his/her ear. Accordingly, an alarm sound can be output when a user reaches a sleepy state while wearing the earphone on his/her ear and another person pulls out the earphone from the user's ear trying to take the smartphone away without asking. In this case, an alarm sound can be output from speaker 5 even if earphone 51 is connected to earphone jack 8. As a result, the user will wake up and warn the other person who tried to take the smartphone away, which can prevent the smartphone from being stolen.

If the earphone is disconnected from the earphone jack in the case where a user's sleepy state has been detected, a user may be informed by other means in addition to an alarm sound. For example, at least one of message display on display module 7, changed luminance of the display in display module 7 and display flashing may be provided. Alternatively, a user may be informed by one or more other means instead of an alarm sound. For example, a user may be informed by vibration of smartphone 1 instead of an alarm sound.

A level of the sleepy state may be detected to change the means for informing in accordance the sleepy state level. For example, if the sleepy state is at a low level, that is, in the light sleep state in which a user will awake even with a slight change in the surrounding environment, he/she may be informed by display module 7 as described above, and if the sleepy state is at a high level, that is, in the deep sleep state, he/she may be informed by an alarm sound. This level may be determined, for example, based on whether or not the pulse interval detected by sleepiness detection module 20 is more than or equal to a predetermined interval. Furthermore, in accordance the sleepy state level, the volume of an alarm sound may be varied, or the amount of vibration of smartphone 1 may be varied.

(Variation)

The present disclosure is not limited to the above-described embodiments, but also includes the following variations, for example.

(1) Method for Detecting Sleepy State

In the above-described embodiments, the user's pulse is measured by the infrared transmitter and the infrared receiver incorporated in the earphone, but this is not a limitation.

For example, a user's pulse may be measured by a bracelet-type pulse sensor as described in Japanese Patent Laying-Open No. 2002-34940.

A user's sleepy state may be detected by a signal other than a pulse.

For example, an image of the user's face may be captured with a camera, the positions of inner and outer corners of user's eyes may be detected by image processing, and a user's sleepy state may be detected depending on the detected positions, as described in Japanese Patent Laying-Open No. 2010-179034 and Japanese Patent Laying-Open No. 2007-313358.

Alternatively, a user's sleepy state may be detected based on a user's eye movement as described in Japanese Patent Laying-Open No. 2007-313358.

Alternatively, a user's sleepy state may be detected by an expiration sensor, a brain-waves sensor or a body temperature sensor as described in Japanese Patent Laying-Open No. 2013-171546.

(2) Electronic Device

Although in the above-described embodiments, a smartphone has been illustrated as an example of electronic device, the electronic device of the present disclosure is not limited to a smartphone, but another type of portable terminal, a personal computer, or a tablet is also included.

(3) Withdrawal of Restriction

In the above-described embodiments, in the case where it is detected, after a restriction, that a sleepy state has been solved and a user has input an instruction to withdraw the restriction through input module 6, control module 4 withdraws the restriction, but this is not a limitation. Control module 4 may withdraw the restriction when either one of the conditions has been met.

Control module 4 may withdraw the restriction in the case where it is detected that the sleepy state has been solved after the restriction. Alternatively, control module 4 may withdraw the restriction in the case where a user has input an instruction to withdraw the restriction through input module 6.

Although the present disclosure has been described and illustrated in detail, it is clearly understood that the same is by way of illustration and example only and is not to be taken by way of limitation, the scope of the present disclosure being interpreted by the terms of the appended claims.

1. An electronic device comprising:
an input module configured to receive an instruction from a user;
a detection module configured to detect a sleepy state of the user; and
a control module configured to, when the user inputs an instruction through said input module in the case where said sleepy state has been detected, impose a restriction on execution of said instruction.

2. The electronic device according to claim 1, wherein said control module is configured to, when the user inputs a specific instruction through said input module in the case where said sleepy state has been detected, effect control such that said specific instruction is not executed.

3. The electronic device according to claim 2, wherein said control module is configured to, when the user inputs an instruction to delete a file through said input module in the case where said sleepy state has been detected, effect control such that said file is not deleted.

4. The electronic device according to claim 2, wherein said control module is configured to, when the user inputs an instruction to make a call through said input module in the case where said sleepy state has been detected, effect control such that a call is not made.

5. The electronic device according to claim 2, wherein said control module is configured to, when the user inputs an instruction to transmit an e-mail message through said input module in the case where said sleepy state has been detected, effect control such that said e-mail message is not transmitted.

6. The electronic device according to claim 1, wherein said control module is configured to, when the user inputs an instruction other than an instruction to withdraw said restriction through said input module in the case where said sleepy state has been detected, effect control such that said instruction input by the user is not executed.

7. The electronic device according to claim 1, wherein said control module is configured to, in the case where it is detected, after said restriction, that said sleepy state has been solved and when the user inputs an instruction to withdraw said restriction through said input module, withdraw said restriction.

8. The electronic device according to claim 1, wherein said detection module is configured to detect a sleepy state of said user based on a pulse of said user.

9. An electronic device comprising:
a detection module configured to detect a sleepy state of a user;
an earphone jack to which an earphone can be connected; and
a control module configured to, when said earphone is disconnected from said earphone jack in the case where said sleepy state has been detected, produce an alarm sound.
